(19) United States
(12) Patent Application Publication
(10) Pub. No.: US 2007/0210892 A1
(43) Pub. Date: Sep. 13, 2007

(54) Surface mount thermostat

(75) Inventors: Brendon John Ruwoldt, New South Wales (AU); Graham Kenneth Smith, New South Wales (AU); Juraj Gacsay, New South Wales (AU); Stephen Gerrard Wooden, New South Wales (AU); Christopher Reis, New South Wales (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Appliance Controls Australia Pty Limited, Pendle Hill (AU)

(21) Appl. No.: 11/488,397

(22) Filed: Jul. 18, 2006

(30) Foreign Application Priority Data
Jul. 19, 2005 (AU) 2005903824

(51) Int. Cl. H01H 37/14

(52) U.S. Cl. 337/377

(57) ABSTRACT

A temperature sensitive switching module for mounting against an outer surface of a container to control operation of a heater heating contents of the container, the switching module including: a temperature sensitive element arranged to deform in dependence upon its temperature to operate a switch; the temperature sensitive element being arranged within the module such that when the module is mounted on the surface of the container, the temperature sensitive element is disposed adjacent the surface of the container with one surface of the element exposed to the surface of the container so as to provide for direct radiated or conducted heat transfer from the container to the element over substantially the whole of the facing surface of the element.

### FIELD OF THE INVENTION

The present invention relates to thermostat devices and, in particular, discloses a snap acting bimetal thermostat that operates in a convenient and compact manner.

### BACKGROUND OF THE INVENTION

Snap acting thermostats are well known. In these thermostats, a bimetallic element acts in a rapid manner to go from a concave to a convex shape. Examples of snap acting thermostats can be seen from, for example, U.S. Pat. No. 5,758,407 to Hickling and U.S. Pat. No. 6,83,3782 to Nguyen.

With the construction of any snap acting thermostat, it is desirable to construct a device in an inexpensive and simple manner.

Any discussion of the prior art throughout the specification should in no way be considered as an admission that such prior art is widely known or forms part of common general knowledge in the field.

### SUMMARY OF THE INVENTION

It is an object of the present invention to provide for an improved form of snap acting thermostat.

In accordance with a first aspect of the present invention, there is provided a temperature sensitive switching module for mounting against an outer surface of a container to control operation of a heater heating contents of the container, the switching module including: a temperature sensitive element arranged to deform in dependence upon its temperature to operate a switch; the temperature sensitive element being arranged within the module such that when the module is mounted on the surface of the container, the temperature sensitive element is disposed adjacent the surface of the container with one surface of the element exposed to the surface of the container so as to provide for direct radiated or conducted heat transfer from the container to the element over substantially the whole of the facing surface of the element.

Preferably, the temperature sensitive element is a bimetal snap-acting disc.

The switch can also include a further temperature sensitive element also arranged within the module such that when the module is mounted on the surface of the container, the temperature sensitive element is disposed adjacent the surface of the container with one surface of the element exposed to the surface of the container so as to provide for direct radiated or conducted heat transfer from the container to the element over substantially the whole of the facing surface of the element. Further, preferably, each temperature sensitive element is associated with a respective electrical switch. Preferably, the temperature sensitive element arranged to open a first switch above a first predetermined temperature threshold and the further temperature sensitive element is arranged to open a second switch above a second, higher temperature threshold.

In an example embodiment, the first switch is arranged to default to a closed position below the first temperature threshold and the second switch is arranged to remain in an open position once opened by the second temperature sensitive element.

Preferably, the switch also includes a single conductive cycling element having two interconnected elongated arms having switch means at distal ends thereof. The end of a first arm switches between an activated and deactivated switch state and the end of the second arm switches between a power on and power off state. The switch further preferably can include a reset unit which can be manually activated so as to switch the second arm from a power off to a power on state.

The switch can also preferably include adjustment means for adjustment of the operational temperature of the switch.

### BRIEF DESCRIPTION OF THE DRAWINGS

Preferred forms of the present invention will now be described with reference to the accompanying drawings in which:

FIG. 1 is a side perspective view of the assembled form of the preferred embodiment;

FIG. 2 is a further side perspective view of the preferred embodiment;

FIG. 3 is a side perspective view of the preferred embodiment with the top cover removed;

FIG. 4 is a bottom side perspective view of the preferred embodiment;

FIG. 5 is a sectional cut away view of the preferred embodiment;

FIG. 6 is a further sectional cut away view of the preferred embodiment;

FIG. 7 is a cut away sectional view of the temperature adjustment portions of the preferred embodiment;

FIG. 8 is a further sectional view of the preferred embodiment; and

FIG. 9a to FIG. 9d illustrates various views of a cycling element of the preferred embodiment.

### DESCRIPTION OF PREFERRED AND OTHER EMBODIMENTS

In the preferred embodiment, there is provided a snap acting bimetallic thermostat device for attachment to a water heater or the like. Of course, the preferred embodiment should not be limited thereto and has general use wherever a thermostat device is required.

In the preferred embodiment, a simplified thermostat device is provided which utilises radiative rather than conductive heat transfer from the monitored device. The utilisation of radiative heat transfer allows for the elimination of a conductive metal plate normally provided in the prior art therefore substantially reducing costs and simplifying operation.

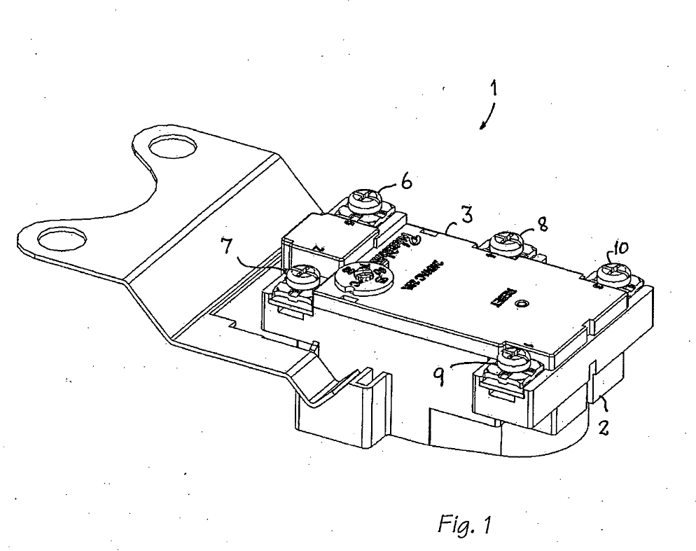

Turning initially to FIG. 1, there is illustrated the final form of the packaged device 1 of the preferred embodiment which includes an outer casing formed from two parts 2 and 3. A mounting bracket 4 is provided for mounting the device to the object which is to be thermally monitored. For example, the device 1 is suitable for use in monitoring hot water tanks.

The device 1 includes a number of external electrical connection terminals at the positions of screws 6-10. The electrical input is provided via a terminal with screw 9 and the neutral is interconnected at the terminal with screw 10. During normal operation, electrical output (to say a heater element) is provided to output at terminal with screw 7. The return neutral from the heater element can be attached to an interconnection at terminal with screw 8 which, during normal operation, is electrically interconnected to terminal at screw 10. On activation of a first thermostat, the electrical output is switched from output at terminal with screw 7 to output at terminal with screw 6 if fitted (terminal 6 being optional). On activation of the second thermostat the electrical connection between inputs at terminal screws 8 and 10 is broken and the electrical interconnection between 9 and 7 is also broken.

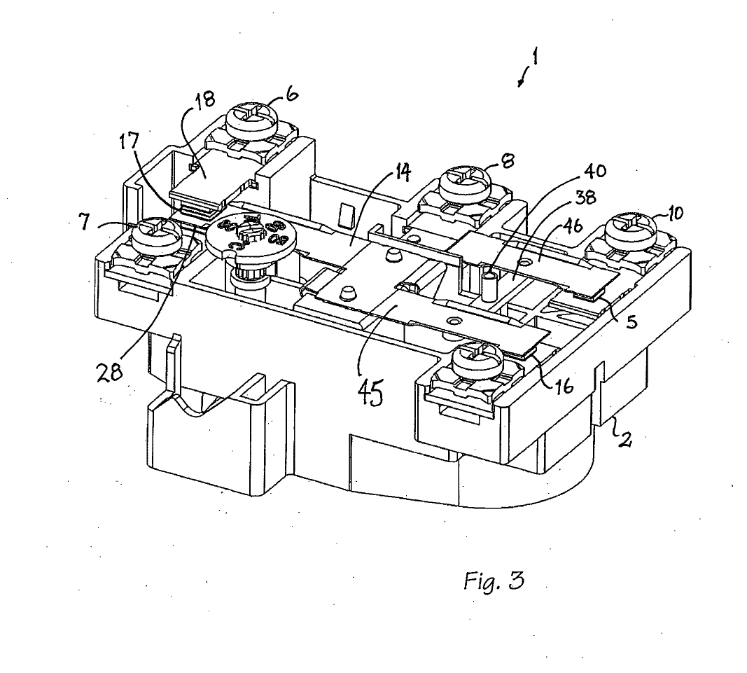

Turning to FIG. 3, there is illustrated the device 1 with the top case part removed. A conductive cycling element is of a general “Z” shape with arms 14, 45 and is formed from one piece having contact pads 17, 16 at its ends and, during normal operation, provides conductive interconnection between input 9 and output 7 or 6.

A separate conductive track arm 46 with pad 15 is provided for a neutral interconnect during normal operation between neutral output terminal screw 8 and neutral input terminal with screw 10. The two conductive arms 46 and 14 are not electrically interconnected. Initially, the power arm 45 of cycling element, which includes conductive switch pad 16 at one end, mates with corresponding mating pads interconnected to screw 9. At the other end there is included a switch pads 17 on the upper and lower surface of the end of cycling arm 14, with the lower surface mating with a contact pad 28 interconnected to the screw 7 and the upper pad mating with a contact pad 18 interconnected to the screw 6. Below the activation temperature, the cycling arm position is as indicated in FIG. 3. Upon activation of a first bimetallic snap switch, the pad 17 at the top surface of the arm 14 then moves to make contact with the mating pad 18 which provides electrical output via screw 6.

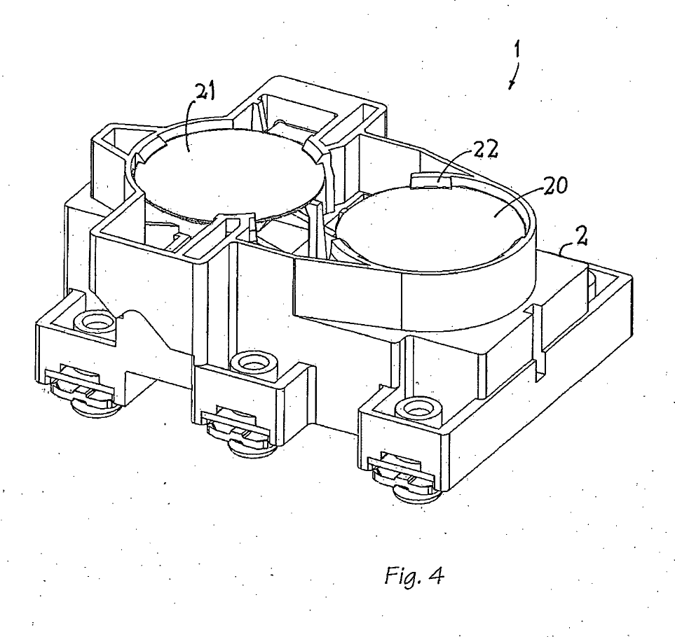

Turning to FIG. 4, there is illustrated a bottom view of the arrangement 1. Two bimetallic snap discs 20, 21 are provided and are held in place by tabs e.g. 22 formed in an injection moulded plastic cover. The bimetallic snap discs 20, 21 are in turn held adjacent to a hot water device or the like and operate by means of radiative heat transfer from the wall of the hot water device. The bimetallic device 20, 21 operate in the normal manner such that, upon the discs heating to a predetermined temperature, the discs are transformed from a first convex state to a second concave state.

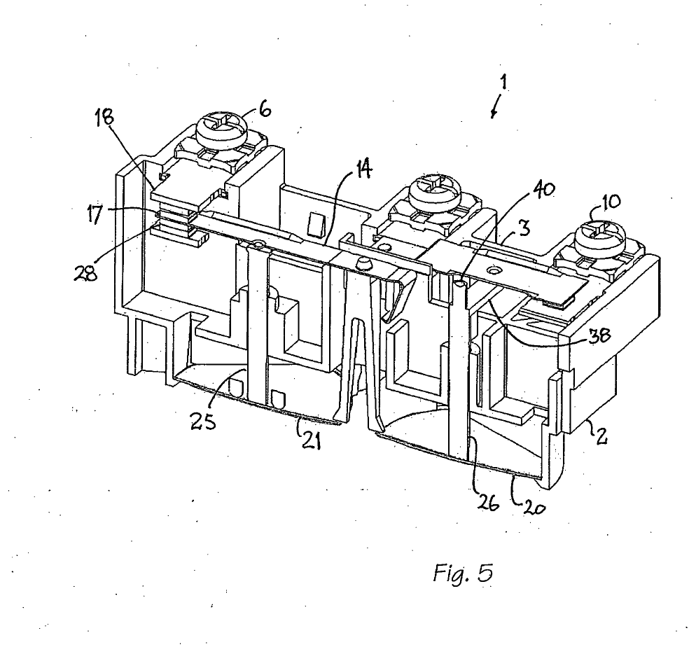

Turning now to FIG. 5, there is illustrated a first sectional view through the arrangement 1. Each bimetallic disc 20, 21 is interconnected to a corresponding rod 25, 26. The rods are activated when the temperature exceeds first and second predetermined limits respectively. The rod 25, upon activation, pushes cycling arm 14 so that switch pad 17 disconnects from its mating pad 28 and moves towards mating pad 18, thereby breaking the connection between terminal 7 and 9 and closes the connection between terminal 6 and 9 (the terminal 6 being optional).

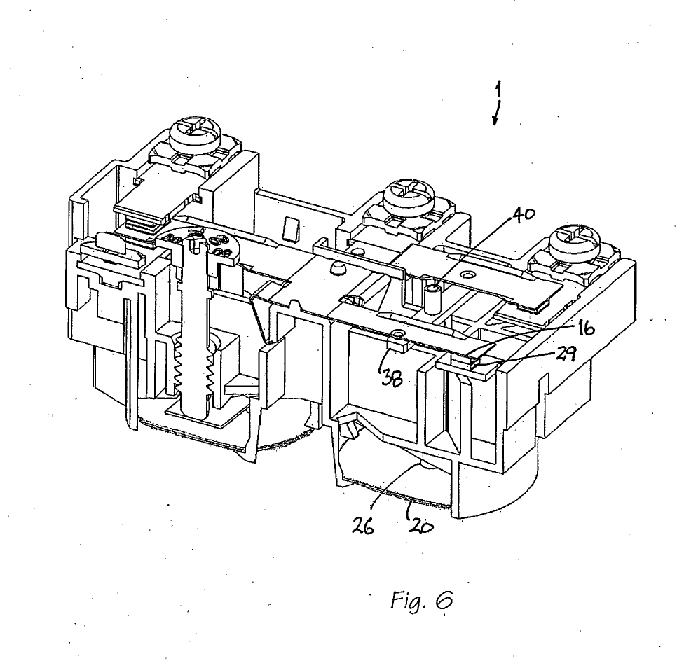

FIG. 6 illustrates a further sectional cut away view of the device 1 illustrating the operation of bimetallic disc 20 in more detail. The disc 20 is interconnected to a manual reset plunger which includes a rod 26 and branching arm 38. Upon operation, the safety bimetal 20 snaps and pushes rod 26. This results in the arm 38 (FIG. 3) pushing arm 45 which breaks connection between terminal 9 and terminal 7 (and terminal 6 if it is fitted). Simultaneously arm 38 pushes arm 46 which breaks the connection between terminal 10 and terminal 8 which is the neutral connection to the heating element.

In operation, in the event of failure of the cycling arm 14, the temperature in the hot water unit will keep rising until the secondary bimetal disc 20 is activated. When this snaps, it pushes onto rod 26 which opens the double pole single throw circuitry cutting off the power supply. To restore the power supply the device must be reset by pushing the reset pin 40 manually which will revert the bimetal to it's original state and will remove pressure from the plunger, thereby allowing the switch 16, 29 to be reactivated as well as switch 15, 35.

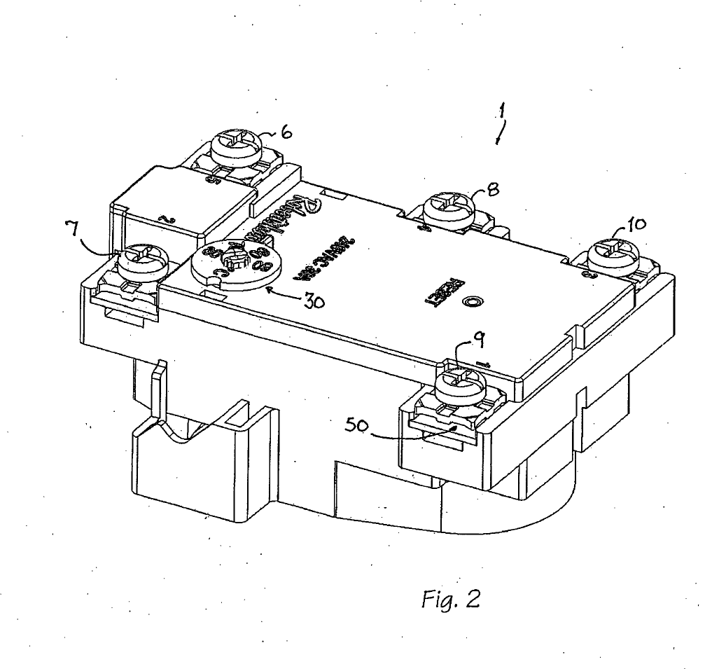

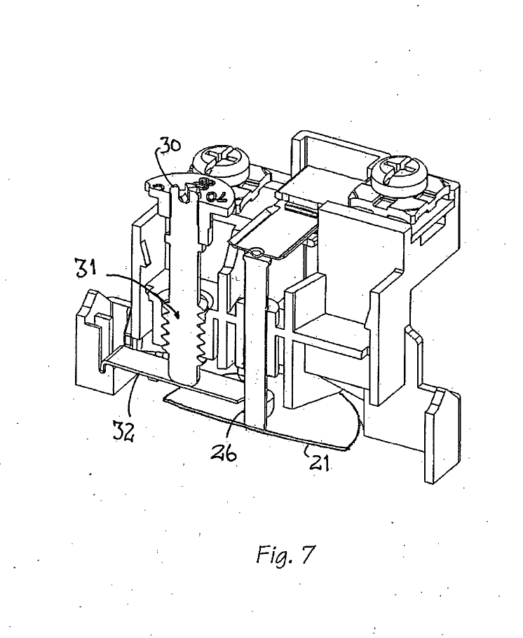

Returning now to FIG. 2, the device 1 also includes activation temperature adjustment means 30. This adjustment mechanism 30 is designed to be rotated so as to provide for a different activation temperature within a limited range. Turning to FIG. 7, there is shown the operational portions of the temperature adjustment device 30. The device includes a rod 31 which upon rotation, a thread in the side wall of rod 31 results in downward movement of the rod. This in turn results in the leaf 32 engaging the bimetallic plates 21, applying pressure thereto and changing the temperature of operation of the plates. In this way, temperature adjustment capabilities are provided.

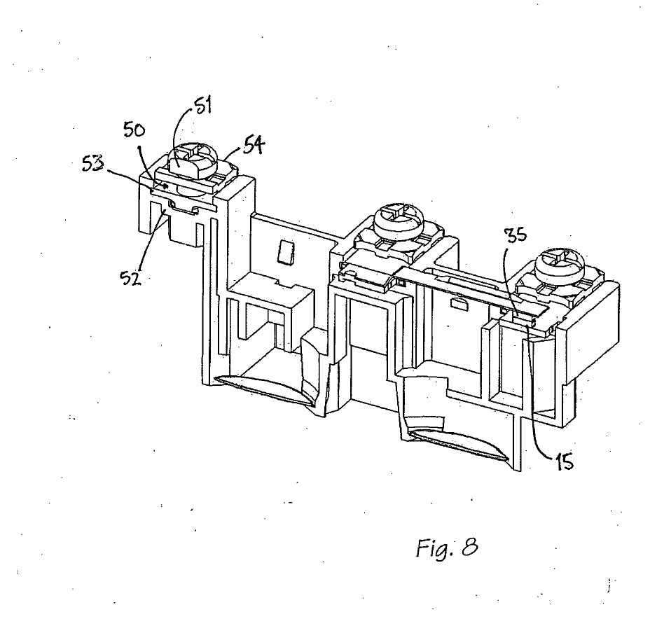

FIG. 8 illustrates a further sectional view illustrating the operation of the contact pads 15, 35.

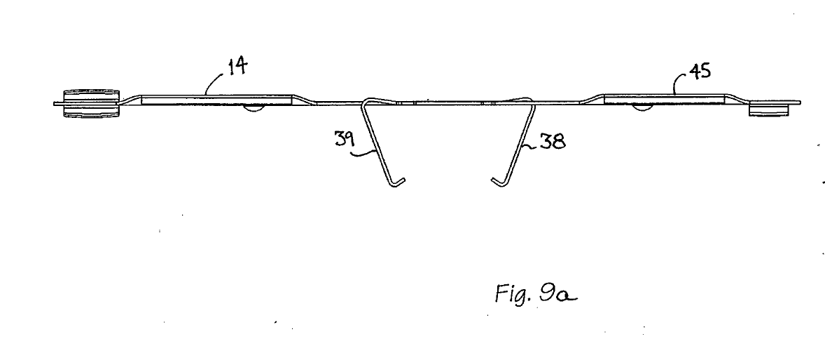

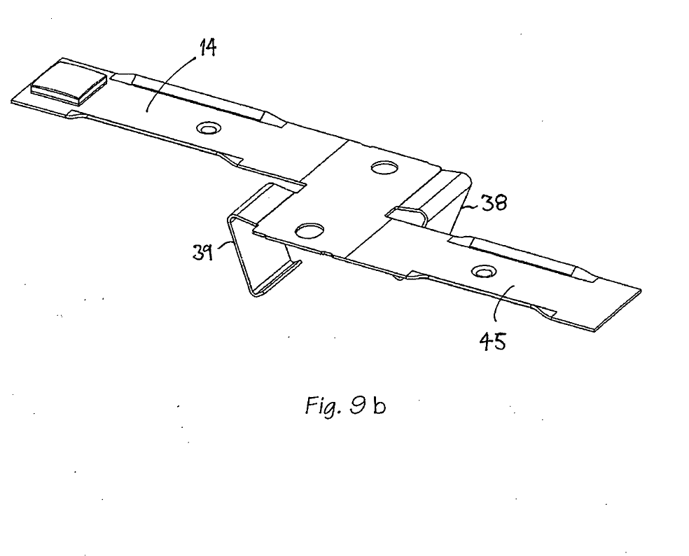

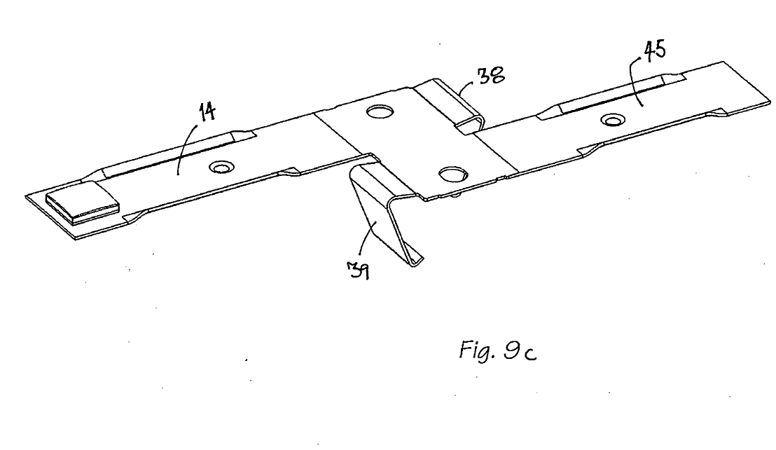

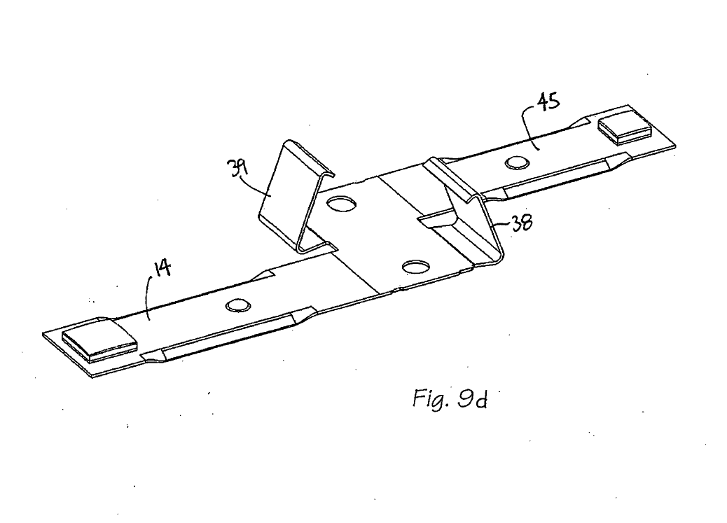

One significant simplification of the preferred embodiment is that the cycling can be provided by one conductive strip. This conductive strip can be snap fitted into place in the injection moulded parts. FIG. 9a to FIG. 9d illustrate various views of the cycling conductive strip which can be formed as a separate part including barbs 38 39 for engaging the injection moulded part.

It should be noted that the preferred embodiment has a number of significant features. These include that the bimetal discs are heated by radiative transfer from the surface of a tank or the like and are held in place by the supporting injection moulded plastic jacket. Hence, a further metallic heat conductive plate has been dispensed with and radiative rather than conductive heat is utilised. The cycling is formed from one piece and simply inserted into the injection moulded frame and held in place by barbs 38, 39. The cycling is formed in one piece with two switching arms eliminating the needs of additional joining which leads to simpler assembly and eliminates the possibility of hot fusing of joints. The switching arms can be simply inserted without requiring additional supporting material.

A further simplification incorporated into the preferred embodiment is the simplified form of contact termination clamping arrangement. Turning to FIG. 2, the example electrical contact with connection 9 can be made by sliding a connector terminal into the slot 53 and using the screw 9 to retain the contact firmly in place. The retaining arrangement is shown in more detail in FIG. 8 which illustrates the contact structure. A connector terminal is inserted into slot 53 and retained using clamping screw 51 so as to engage with body 2,52 to prevent lateral movement of the connector terminal 50. This negates the need to separately rivet the connector terminal 50 in place. Termination is captured between connector terminal 50 and washer 54.

The foregoing describes preferred forms of the present invention. Modifications, obvious to those skilled in the art can be made thereto without departing from the scope of the invention.

1. A temperature sensitive switching module for mounting against an outer surface of a container, the switching module including:
a temperature sensitive element arranged to deform in dependence upon its temperature to operate a switch;
the temperature sensitive element being arranged within the module such that when the module is mounted on the surface of the container, the temperature sensitive element is disposed adjacent the surface of the container with one surface of the element exposed to the surface of the container so as to provide for direct radiated or conducted heat transfer from the container to the element over substantially the whole of the facing surface of the element.

2. A temperature sensitive switching module according to claim 1, wherein the temperature sensitive element is a bimetal snap-acting disc.

3. A temperature sensitive switching module according to claim 1, including a further second temperature sensitive element also arranged within the module such that when the module is mounted on the surface of the container, the second temperature sensitive element is disposed adjacent the surface of the container with one surface of the element exposed to the surface of the container so as to provide for direct radiated or conducted heat transfer from the container to the element over substantially the whole of the facing surface of the element.

4. A temperature sensitive switching module according to claim 3, wherein each said temperature sensitive element is associated with a respective electrical switch.

5. A temperature sensitive switching module according to claim 4, wherein the temperature sensitive element is arranged to open a first switch above a first predetermined temperature threshold and the further second temperature sensitive element is arranged to open a second switch above a second, higher temperature threshold.

6. A temperature sensitive switching module according to claim 5, wherein the first switch is arranged to default to a closed position below the first temperature threshold and the second switch is arranged to remain in an open position once opened by the second temperature sensitive element.

7. A temperature sensitive switch as claimed claim 1 further comprising a single conductive cycling element having two interconnected elongated arms having switch means at distal ends thereof.

8. A switch as claimed in claim 7 wherein the end of a first arm switch between an activated and deactivated switch state and the end of the second arm switches between a power on and power off state.

9. A switch as claimed in claim 7 wherein said switch further includes a reset unit which can be manually activated so as to switch said second arm from a power off to a power on state.

10. A temperature sensitive switch as claimed in claim 1 further including adjustment means for adjustment of the operational temperature of the switch.

11. A temperature sensitive switch as claimed in claim 2 wherein said snap acting disc is held in place in a plastic jacket.

12. A switch as claimed in claim 7 wherein said cycling includes a series of locator leaf strips attach to the surface thereof and adapted to engage profiled surfaces on the switch body so as to located said cycling in said switch.

13. A switch as claimed in claim 1 with said switch having a series of contact units adapted to take a slide in contact plate and retained by a clamping screw which engages the body of the switch.

14. A temperature sensitive switching module for mounting against an outer surface of a container to control operation of a heater heating contents of the container, the switching module including:
a temperature sensitive element arranged to deform in dependence upon its temperature to operate a switch;
the temperature sensitive element being arranged within the module such that when the module is mounted on the surface of the container, the temperature sensitive element is disposed adjacent the surface of the container with one surface of the element exposed to the surface of the container so as to provide for direct radiated heat transfer from the container to the element over substantially the whole of the facing surface of the element.

15. A temperature sensitive switch substantially as herein described with reference to any one of the embodiments of the invention illustrated in the accompanying drawings and/or examples.
